(19) United States
(12) Patent Application Publication
(10) Pub. No.: US 2010/0293036 A1
(43) Pub. Date: Nov. 18, 2010

(54) DEVICE AND A METHOD FOR UPDATING A USER PROFILE

(75) Inventors: Franck Meyer, Lannion (FR); Julien Schluth, Lannion (FR); Damien Hembert, Lannion (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/780,343

(22) Filed: May 14, 2010

(30) Foreign Application Priority Data
May 15, 2009 (FR) 09 53250

(51) Int. Cl. G06Q 10/00; G06F 3/048

(52) U.S. Cl. 705/10; 715/810

(57) ABSTRACT

A device is provided for updating a user profile stored in a memory accessible to the device. The device includes a display screen for displaying a graphical user interface representing a product page showing a plurality of descriptors. The device is such that each of at least some of the plurality of descriptors of the viewed product page is associated with an interest indicator linked to the user profile and represented on the graphical user interface by an illustration. The device includes a user interface for selecting an illustration representing an interest indicator for a descriptor from the product page and for selecting an illustration from a set of illustrations representing different levels of interest. The level of interest corresponds to the selected illustration being stored for updating the user profile. Also, methods are provided for updating a user profile and providing product recommendations using such a profile.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to a device for updating a user profile including user preference characteristics via a graphical user interface and user interface means.

A user profile may in particular be used in search engines to personalize searching and may also be useful in on-line sales or on-line services where the goods or services offered to the user are selected as a function of preferences indicated in the user profile.

### BACKGROUND OF THE DISCLOSURE

There are many applications for recommending services, goods or contents that, for theme-based filtering systems, require efficient configuration of the user profile to obtain a recommendation of interest.

In on-line sales and multimedia product consultation services, for example the on-line multimedia product sales system of the Internet site www.Amazon.com, the user can view a product page describing the characteristics of the product and post their opinion of the product in question.

This opinion can then be used to recommend other products to the user. Such recommendations are rough and ready, however, because they are based only on rating goods having many different characteristics.

To be able to refine their user profile, the user must access a profile configuration page. A particular configuration menu or screen is then displayed to the user for them to specify their preferences.

Thus before being able to enjoy a personalized recommendation or display of personalized information, the user must complete a form giving their preferences for particular themes or products, in order to define their user profile.

Selecting options from a preference menu or configuration screen can be laborious for users, who must simultaneously post their preferences for a large number of themes or products. This configuration step precedes a service being offered to the user and takes the user a non-negligible length of time.

This configuration step is time-consuming and increases the complexity of the services offered to the user.

There is therefore a requirement to reduce the time and complexity of updating user profiles.

### SUMMARY

An aspect of the present disclosure relates to a device for updating a user profile stored in a memory accessible to the device, the device including a display screen for displaying a graphical user interface representing a product page showing a plurality of descriptors. The device is such that each of at least some of the plurality of descriptors of the displayed product page is associated with an interest indicator linked to the user profile and represented on the graphical user interface by an illustration and it includes user interface means for selecting an illustration representing an interest indicator for a descriptor from the product page and for selecting an illustration from a set of illustrations representing different levels of interest, the level of interest corresponding to the selected illustration being stored for updating the user profile.

Thus displaying a product page describing a single product enables the user to define their preferences by assigning levels of interest to descriptors that describe the product.

These rated descriptors thus make it possible to update the user profile without going through any step of configuring the profile as such or going to a specific configuration menu.

Simply consulting an electronic page describing a product offers the user the possibility of refining or modifying their profile by indicating their preferences in a plurality of descriptors.

Thus the user wastes no time in configuring their profile and can do this as and when they look up various products.

The interface offered to the user is furthermore very simple and facilitates the configuration task for the user.

The various features of the disclosure referred to below may be combined with the above-mentioned features separately or in combination.

In one possible embodiment, the graphical user interface representing a product page further includes a product interest indicator configurable via the user interface means.

Thus the user is able not only to specify their preferences in the descriptors of the product displayed but also on the product itself, which provides further information for defining their user profile.

In one particular embodiment, the set of illustrations representing different levels of interest consists of icons displayed by the display screen representing faces with expressions of different degrees of happiness or sadness.

Simply selecting an illustration representing the level of interest to be specified for a given descriptor triggers the display of a plurality of possible levels. This interaction with the user is therefore very simple.

In one advantageous embodiment, the interest indicator of the product is used to update the interest indicators corresponding to at least some of the descriptors of the product for storage in the user profile.

Thus implicit configuration of the user profile is possible. In addition to information actually entered by the user in descriptors of certain product pages, the user's rating as shown on the product itself enables automatic assignment of levels of interest to certain descriptors of the product in question in order to update the user profile automatically.

In one particular embodiment, descriptors stored in the user profile are furthermore updated taking account of the use by the user of the displayed product page.

Thus implicit updating of the user profile is possible. The tasks that the user effects after a product page is displayed shows their degree of interest in the product and are therefore used to update their profile transparently.

The display screen advantageously takes into account the stored interest indicators to display descriptors of a new product page.

When the user displays a new product page, they therefore see on the descriptors common to this new page interest indicators that they have already specified during prior consultation of product pages or after configuring the indicators implicitly.

This therefore provides them with immediate information on the interest they might have in the new product.

In one particular embodiment, the graphical user interface representing the product page further includes a displayed list of products having the most descriptors in common with the product of said page.

Thus the user is offered a possible product selection matching the descriptors of the products consulted so that they can easily select other products likely to be of interest to them.

The disclosure also provides a multimedia terminal including a device as described above.

This terminal can be a computer, for example, a multimedia player, a mobile telephone, a TV decoder connected to a television or more generally any multimedia terminal.

The disclosure also provides a method of updating a user profile via a graphical user interface representing a product page on which a plurality of descriptors of the product is displayed. The method is such that each of at least some of the descriptors of the product page is associated with an interest indicator linked to the user profile and represented by an illustration and includes the following steps:
selecting an illustration representing an interest indicator for a descriptor from the product page;
displaying a set of illustrations representing different levels of interest;
selecting an illustration in the displayed set;
updating the user profile by storing the level of interest corresponding to the illustration selected for the corresponding descriptor.

It further provides a method of recommending products that takes account of a user profile updated by a method as described above.

A clearly-defined user profile can improve the recommendation of products for the user.

Finally, the disclosure provides a computer program including code instructions for executing a method as described above of updating a user profile when they are executed by a processor.

### BRIEF DESCRIPTION OF THE DRAWINGS

Other features and advantages become more clearly apparent on reading the following description, given by way of non-limiting example only and with reference to the appended drawings, in which:

FIG. 1 shows a device for updating a user profile of one embodiment of the disclosure;

FIG. 2 shows for one embodiment of the disclosure an example of a graphical user interface of a product page with descriptors to be updated;

FIG. 3 shows in flowchart form the steps of the method of updating a user profile of one implementation of the disclosure;

FIG. 4a shows an example of the content of the product database in one embodiment of the disclosure;

FIG. 4b shows an example of the content of the user profile database in one embodiment of the disclosure;

FIG. 4c shows examples of weighting user usages stored in the user profile database;

FIG. 4d shows examples of rating a type of action;

FIG. 5 shows in flowchart form the steps of updating a user profile implicitly in one implementation of the disclosure; and

FIG. 6 shows in flowchart form the steps of a recommendation method of one implementation of the disclosure.

### DETAILED DESCRIPTION OF ILLUSTRATIVE EMBODIMENTS

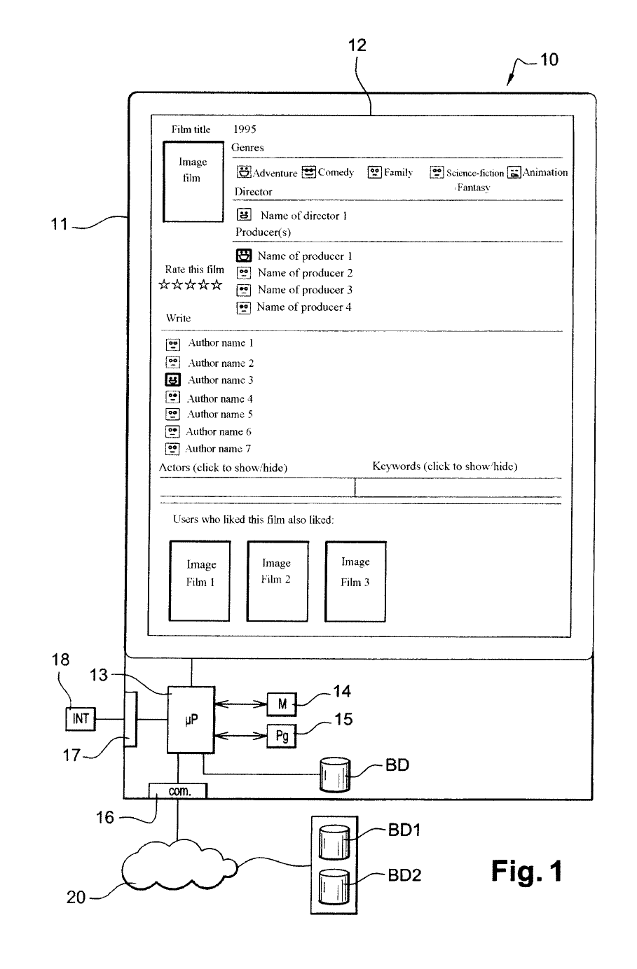

FIG. 1 shows a device for updating a user profile of one embodiment of the disclosure. This device can typically be integrated into a computer, a multimedia player, a communications terminal such as a mobile telephone, a TV decoder connected to a television or more generally any multimedia equipment.

This device 10 includes a display screen 11 displaying a graphical user interface 12. For an on-line sales application, for example, during display of a product page describing a product on sale the interface displays a description of the product and its various features.

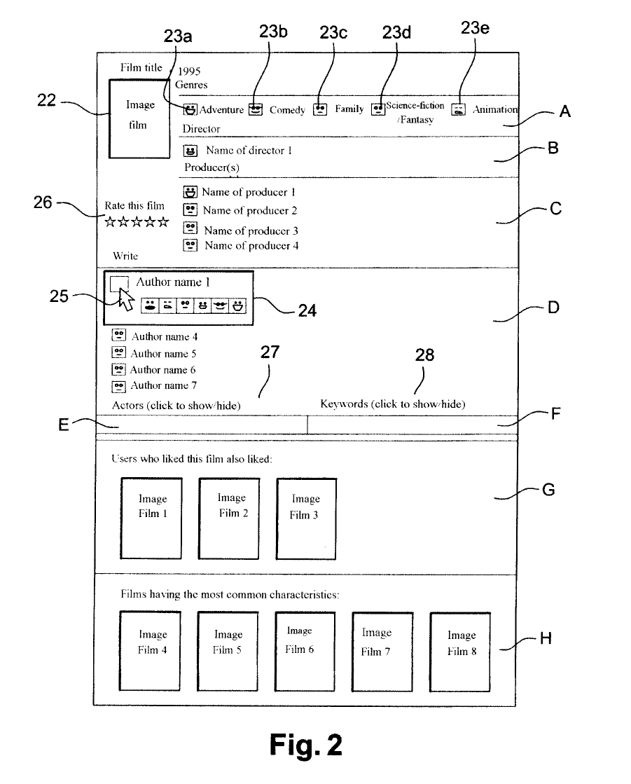

A product page as displayed on this screen includes a plurality of descriptors. In the example shown in FIG. 1 and discussed in more detail with reference to FIG. 2, the product is a DVD of a film. The descriptors of this film are for example its genre (adventure, comedy, drama, science-fiction/fantasy, animation, etc.), the name of the producer, the name of the screenwriter, the names of the actors or keywords relating to the story of the film concerned.

According to an example of the disclosure, each of at least some of the descriptors of the product page is associated with an interest indicator shown on the graphical user interface. The interest indicator represents the interest of the user in this particular descriptor. Here the illustrations of these interest indicators represent faces with different expressions. Accordingly, for the comedy genre, for example, the user can choose an interest indicator illustrated by a happy face to show their high interest in comedy films. In contrast, the user can choose an illustration representing a very sad face to show that they do not like comedy films.

Accordingly, the user can select an interest indicator using the graphical user interface of a product page. The user selecting an indicator to be configured has a choice between various interest indicators described with reference to FIG. 2.

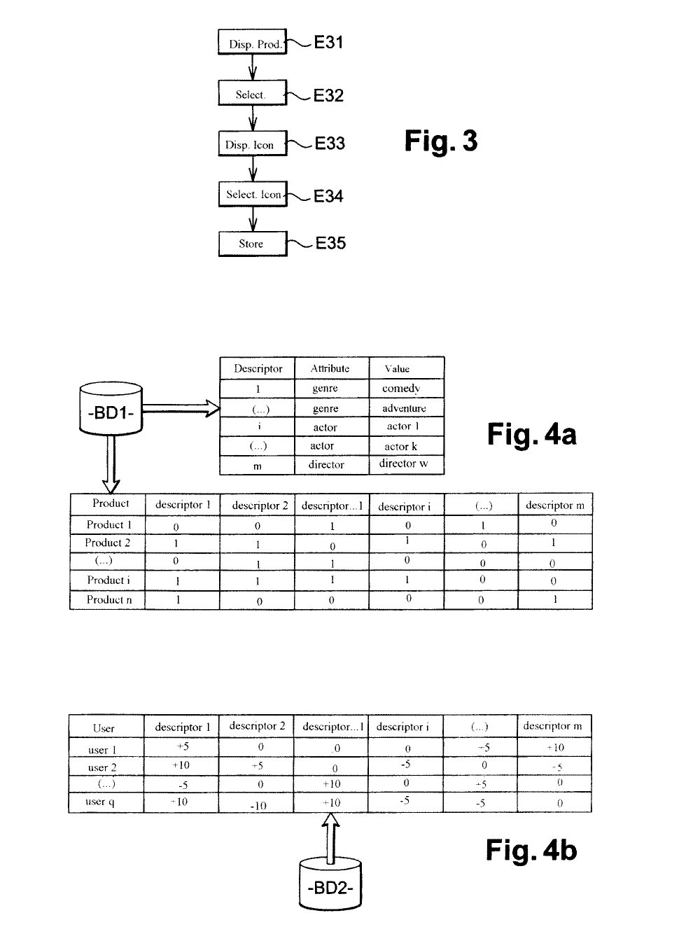

This device further includes a processor unit 13 provided with a microprocessor and connected to a memory 14. The processor unit is controlled by a computer program 15 in order in particular to implement the method of one implementation of the disclosure described below with reference to FIG. 3 of updating a user profile, for example.

The computer program includes code instructions for executing the steps of the method of updating the user profile and in particular steps of:
selecting an illustration representing an interest indicator for a descriptor on the product page;
displaying a set of illustrations representing different levels of interest;
selecting an illustration in the displayed set;
updating the user profile by storing the interest level corresponding to the illustration selected for the corresponding descriptor.

The computer program can also execute the steps of a recommendation method as described with reference to FIG. 6.

It can further execute the steps of a method of implicitly updating a user profile described with reference to FIG. 5.

Via an input module 17, the processor unit receives instructions from a user interface 18, for example a computer mouse or any other means enabling the user to select items on the display screen. The processor unit thus receives interest indicators for certain descriptors chosen by the user on the graphical user interface of the product page.

These interest indicators are then stored in a memory accessible by the device 10. This memory can be internal, for example, such as a database BD, or external, such as a database BD2 in a server and accessed by the device 10 via a communications module 16 and a communications network 20.

Other types of memory can of course be envisaged, such as removable memory media.

The device 10 has access to a first database BD1 stored on a server that offers an on-line consultation or sales service, for example, and that includes all the characteristics of products shown to the user. This database contains the descriptors of the products.

The device has access to the database BD2 for initially storing interest indicators chosen by the user and for updating the user profile or creating a profile for a new user.

The server hosting the databases BD1 and BD2 can itself execute the steps of a recommendation method described below with reference to FIG. 6 and the steps of a method of implicitly updating a user profile described with reference to FIG. 5.

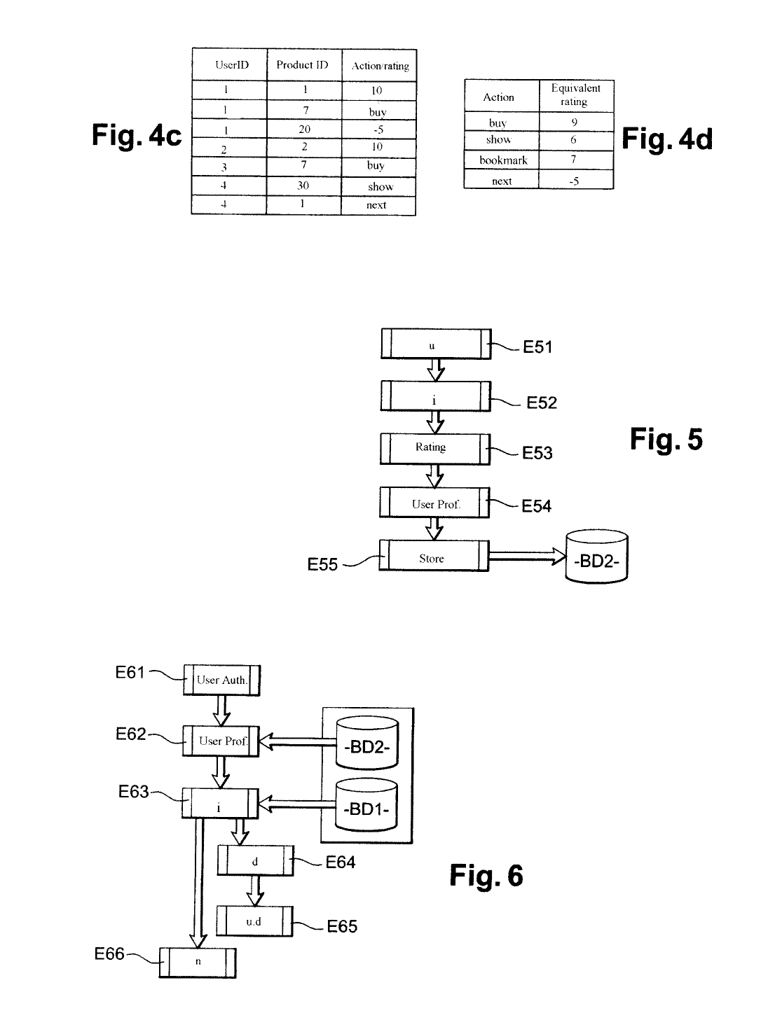

FIGS. 4a and 4b represent examples of the contents of these databases.

When the device is displaying a product page, the processor unit takes account of the user profile that it retrieves from the database BD2 via a communications network or from its internal database BD in order to display icons corresponding to interest indicators that the user has already configured for descriptors common to the displayed page.

Thus the user can see how interesting the product might be for them at a glance. They can also modify the interest indicators that they have configured already or configure other indicators. However, the user does this at the same time as consulting a product page, which saves time. They do not need to go to a specific configuration screen.

The graphical user interface representing a product page is described below with reference to FIG. 2.

In the example represented here, the product is a DVD of a film. It can of course be any type of product to be consulted on a display screen. The products can be objects, music, books, video contents, etc. These products have their own descriptors.

Here an image 22 of the cover of the DVD to be consulted is displayed. The title of the film in question is also displayed as well as the year of its release, for example.

In a first window A the film genre descriptors are displayed. Here the film is an animated family comedy science-fiction/fantasy adventure film.

An icon that the user can configure is associated with each of these descriptors. The icon represented shows a face that may adopt various expressions. Thus the icon for the adventure genre represents a happy face 23a and that for the animation genre represents a somewhat sad face.

To accentuate the visual impact of these representations, the various icons may also be different colors.

A second window B shows descriptors including the name of the director.

A third window C shows the names of the producers of the film and the associated icons.

Another window D shows the names of the screenwriters. The windows E and F show the names of the actors or keywords defining the film, for example. These names can be concealed or shown according to whether the user chooses to display them or not by clicking on the appropriate option.

If the user wishes to define or modify an interest indicator for one of the descriptors, they point to the icon 25 of the descriptor in question using their pointing device, such as their mouse. On selecting this icon, for example by clicking on it with the mouse, a window 24 is opened showing a set of illustrations representing various levels of interest that the user can choose.

Here, six levels of interest are shown in the form of icons representing faces with different expressions.

The user then has only to point to the icon that represents their interest in the descriptor.

The processor module described with reference to FIG. 1 then takes this selection into account to store the corresponding interest indicator in the database BD2 and to update the user profile in that database.

The icon representing a face with no expression here represents the fact that the user has no opinion on the chosen descriptor. It is this icon that is displayed by default for descriptors that have not yet been rated by the user.

The user can also globally rate the product itself by indicating a rating on the product. For example, this rating takes the form of stars 26 that the user fills in by clicking on them. The more stars are filled in, the greater the interest in the product.

This information on the rating of the product is also stored in the database BD2 and can be used to update the user profile implicitly, as explained below with reference to FIG. 5.

The graphical user interface also includes windows G and H in which other films are recommended. These recommendations can be a function of the interest of other users in this film or other films or a function of the number of descriptors in common with other films, for example.

Of course, the numbers of descriptors and windows can be different and the disposition of these features is not restricted to the example shown here. Different dispositions or options can be provided for implementing one or more embodiments of the disclosure.

FIG. 3 represents the main steps of a method of updating a user profile. A first step E31 (Disp.Prod.) displays a product page including a plurality of descriptors. An interest indicator represented by an illustration, for example an icon, is associated with at least some of these descriptors.

In step E32 (Select.), the user selects an illustration representing an interest indicator for a descriptor of the displayed page. This step is followed by a step E33 (Disp.Icon) of displaying a set of interest indicator illustrations of different levels, as shown in FIG. 2 described above.

In step E34 (Select.Icon), the user selects in this set of illustrations the one that corresponds to the interest indicator that they wish to store.

Step E34 is followed by step E35 (Store) in which the selected interest indicator is stored in a memory or a database for updating the user profile concerned.

To know the user concerned and the user profile to be updated, a user authentication phase is possible first. This authentication phase is well known in existing systems and is not described here.

An example of the data contained in the databases BD1 and BD2 described with reference to FIG. 1 is described below.

The database BD1 containing data on products and the associated descriptors is described with reference to FIG. 4a.

Each descriptor is a characteristic of a product represented by an attribute and a value ((attribute, value) pair). Characteristics with numerical values can be grouped by ranges of values.

For the application described here, for example, this database includes a first table including descriptors that describe the product. Note that here, for example, a first descriptor (in row 1 of the descriptor table) associates an attribute “genre” with a value “comedy”. Another descriptor i associates an attribute “actor” with the value “actor 1”.

This descriptor table therefore contains as many rows as there are descriptors, a descriptor consisting of an (attribute, value) pair.

The database BD1 also includes a second product table in which a row corresponds to a product and a column corresponds to a descriptor. A value 0 or 1 is assigned to the (product, descriptor) pair according to whether the product includes the descriptor in question or not. For example, the value 1 indicates that the descriptor exists for the product concerned and the value 0 indicates that the descriptor does not exist for that product.

The products are thus represented here by descriptor vectors with 0 or 1 components.

Note that here, in row 1 corresponding to product 1, this product does not have descriptors 1, 2, i and m although it does have descriptors . . . 1 and ( . . . ). The tables shown have been limited to a predefined number of rows and columns and are of course adapted as a function of the number of products that the service offers for consultation and the number of associated descriptors.

There is described below with reference to FIG. 4b an example of the content of the user profile database BD2. A row of the table represents a user and a column represents a descriptor. Each (user, descriptor) pair is associated with a rating according to any interest indicators that the user may have configured on any product pages that they may have consulted.

Accordingly, the rating is 0 if there is no stored information as to the interest of the user in a descriptor. The rating is positive if the user has specified an interest in this descriptor and negative if the user has specified a lack of interest in the descriptor. The higher the positive rating, the greater the interest. Selection by the user 1 of a high interest indicator value on the graphical user interface for a descriptor increases the value of the (user 1, descriptor) pair in the table and thus updates the profile of the user 1.

The users are thus represented here by vectors of descriptors with components between a maximum positive value and a maximum negative value inclusive. The maximum values are a function of the notation scale offered to the user.

The user profiles and the products are represented here in the same vector space constructed on m descriptors.

The database BD2 may equally include another table that takes into account the overall rating that a user may have given to the product as explained with reference to FIG. 2 or the use that the user makes of the displayed product page.

Thus the table shown in FIG. 4c represents for a given user (UserID) and a given product (ProductID) either the rating posted for or the action effected on the product, such as buy, show or go to next product.

An example of ratings for given types of action is defined in the table represented in FIG. 4d. Thus in FIG. 4d the rating for a buy action is 9, the rating for a show action is 6, the rating for a bookmark action (storing the product page in the user's favorites) is 7, and the rating for the go to next product action is −5.

These rating values are obviously no more than possible examples. Other rating values are possible and other types of actions may be envisaged.

These ratings are used to update the user profiles implicitly in an example of a method described below with reference to FIG. 5.

FIG. 5 shows the main steps of implicitly updating the user profile both as a function of the overall rating that the user may have assigned to a product that they have looked at and also as a function of the use that the user has made of their consultation of the product.

Accordingly, step E51 defines the user u, for example by authentication. In step E52, the user views a product i.

If the user has posted a rating of the product, for example as described with reference to FIG. 2, the rating is stored in relation to the product i and the user u in step E53. Likewise, if the user effects an action for which a rating has been defined in an assignment table as defined with reference to FIG. 4d, for example, then the corresponding rating is linked to the product i and the user u.

The vector corresponding to the product i is weighted by the rating of the user u on the product i and is added to the profile vector of the user u in step E54.

The user profile u is updated in the database BD2 in step E55.

According to the descriptors defining the product i as represented in Table 4a, the user profile u defined in Table 4b is updated by weighting the corresponding descriptors by the rating obtained in step E53.

Thus the interest indicator configuration process is used to update the interest indicators corresponding to at least some of the descriptors of the product to be stored in the user profile.

Thus when the user displays a product page, the device updates the icons corresponding to the descriptors for which a value has been defined as a function of the stored user profile. Thus the user sees very quickly how interested they might be in the displayed product.

Implicit updating of the profile is transparent to the user and also saves time. This accelerates updating the profile, the user thereafter finding it a simple matter to modify the interest indicators of the descriptors when displaying a product page containing the same descriptors.

There are numerous examples of use of user profiles updated by the method described above.

These user profiles can be used to recommend products to a particular user, for example.

One example of this type of product recommendation is described below with reference to FIG. 6. This figure represents the main steps of a recommendation method using a user profile configured by the method described with reference to FIG. 3, for example.

Accordingly, the user u is authenticated in step E61. In step E62, the database BD2 containing the user profiles is consulted. The profile of the authenticated user u is extracted from it. In the present example this profile corresponds to a vector including the ratings or interest indicators given to various product descriptors.

In step E63, the database BD1 is consulted. The products contained in this database are consulted one by one. The descriptor vector d associated with a current product i is extracted in step E64.

During step E65, the interest rating of the user u for the product i is calculated. This rating is the scalar product of the user vector u by the descriptor vector d, for example.

During step E66, a set of n products with the best ratings is recovered. A configurable threshold is set to determine these best ratings, for example. The n products likely to interest the user u the most are obtained in this way. These products are sorted by decreasing rating order, for example.

This list of products is displayed on the user interface, for example, either in an independent window following a user request for products likely to interest them or while consulting a product page, for example in a window of type G or H as described with reference to FIG. 2.

Other types of application can also use such user profiles.

One possible application is comparing different user profiles defined as above to find users who have the greatest affinities, for example those who have the most identically rated common descriptors, to put them in touch with each other or to offer them common services.

Although the present disclosure has been described with reference to one or more examples, workers skilled in the art will recognize that changes may be made in form and detail without departing from the scope of the disclosure and/or the appended claims.

What is claimed is:

1. A device for updating a user profile stored in a memory accessible to the device, the device comprising:
a display screen for displaying a graphical user interface representing a product page showing a plurality of descriptors, wherein each of at least some of the plurality of descriptors of the displayed product page is associated with an interest indicator linked to the user profile and represented on the graphical user interface by an illustration; and
user interface means for selecting an illustration representing an interest indicator for a descriptor from the product page and for selecting an illustration from a set of illustrations representing different levels of interest, the level of interest corresponding to the selected illustration being stored for updating the user profile.

2. The device according to claim 1, wherein the graphical user interface representing a product page further includes a product interest indicator configurable via the user interface means.

3. The device according to claim 1, wherein the set of illustrations representing different levels of interest comprises icons displayed by the display screen representing faces with expressions of different degrees of happiness or sadness.

4. The device according to claim 2, wherein the device is configured to use the interest indicator of the product to update the interest indicators corresponding to at least some of the descriptors of the product for storage in the user profile.

5. The device according to claim 1, wherein the device is configured to update the descriptors stored in the user profile by taking account of use by the user of the displayed product page.

6. The device according to claim 1, wherein the display screen takes into account the stored interest indicators to display descriptors of a new product page.

7. The device according to claim 1, wherein the graphical user interface representing the product page further includes a displayed list of products having the most descriptors in common with the product of said page.

8. A multimedia terminal including a device according to claim 1.

9. A method of updating a user profile via a graphical user interface representing a product page on which a plurality of descriptors of the product is displayed, wherein each of at least some of the descriptors of the product page is associated with an interest indicator linked to the user profile and represented by an illustration, and the method includes the following steps:
selecting an illustration representing an interest indicator for a descriptor from the product page;
displaying a set of illustrations representing different levels of interest;
selecting an illustration in the displayed set; and
updating the user profile by storing the level of interest corresponding to the illustration selected for the corresponding descriptor.

10. The method of claim 9, which further comprises:
displaying a list of at least one recommended product on the display, which takes into account the user profile updated by the method according to claim 9.

11. A computer program including code instructions, which when executed by a processor, perform a method of updating a user profile via a graphical user interface representing a product page on which a plurality of descriptors of the product is displayed, wherein each of at least some of the descriptors of the product page is associated with an interest indicator linked to the user profile and represented by an illustration, wherein the method comprises:
selecting an illustration representing an interest indicator for a descriptor from the product page;
displaying a set of illustrations representing different levels of interest;
selecting an illustration in the displayed set; and
updating the user profile by storing the level of interest corresponding to the illustration selected for the corresponding descriptor.
